(19) United States
(12) Patent Application Publication
(10) Pub. No.: US 2017/0346154 A1
(43) Pub. Date: Nov. 30, 2017

(54) WINDOW GLASS FOR VEHICLE

(71) Applicant: ASAHI GLASS COMPANY, LIMITED, Tokyo (JP)

(72) Inventor: Osamu KAGAYA, Tokyo (JP)

(73) Assignee: ASAHI GLASS COMPANY, LIMITED, Tokyo (JP)

(21) Appl. No.: 15/585,003

(22) Filed: May 2, 2017

(30) Foreign Application Priority Data
May 24, 2016 (JP) 2016-103691

(51) Int. Cl. H01Q 1/12; H01Q 13/10; H01Q 1/32

(52) U.S. Cl. CPC H01Q 1/1271; H01Q 1/325; H01Q 13/10

(57) ABSTRACT

A window glass for vehicle includes a glass plate; a dielectric body; and a conducting body arranged between the glass plate and the dielectric body. The conducting body includes a pair of feeding units; a first slot having a first open end that opens at an outer periphery of the conducting body, and extending from the first open end and through between the pair of feeding units; a second slot having a second open end that opens at the outer periphery of the conducting body, extending from the second open end, and being connected to the first slot; and a third slot having a non-open end that does not open at the outer periphery of the conducting body, extending from the non-open end, and being connected to the first slot and the second slot.

### CROSS-REFERENCE TO RELATED APPLICATION

The present application is based on and claims benefit of priority under 35 U.S.C. §119 of Japanese Patent Application No. 2016-103691, filed May 24, 2016. The contents of the application are incorporated herein by reference in their entirety.

### BACKGROUND OF THE INVENTION

### 1. Field of the Invention

The disclosure herein generally relates to a window glass for vehicle.

### 2. Description of the Related Art

Window glasses for vehicle, each of which is provided with a conductive film between two glass plates have been known. In such window glasses for vehicle, when an antenna conductor is arranged on a vehicle internal side, electric waves coming from a vehicle external side are shielded by the conductive film, and thereby reception characteristics required for the antenna conductor may not be obtained sufficiently.

In order to eliminate such an adverse effect, window glasses, each of which has an antenna function using the conductive film, have been known (for example, see Japanese Unexamined Patent Application Publication No. H6-45817 and Japanese Unexamined Patent Application Publication No. H9-175166). Japanese Unexamined Patent Application Publication No. H6-45817 and Japanese Unexamined Patent Application Publication No. H9-175166 disclose slot antennas, each of which uses a slot between a flange of a vehicle body to which the glass plate is fixed and the conductive film.

In the case of the slot antenna that uses the slot between the flange and the conductive film, a resonance frequency of the slot antenna varies depending on a size of the slot. However, because an error in an attachment position, when the glass plate is attached to the flange, is relatively great, the size of the slot fluctuates easily. Therefore, it is difficult to cause the slot antenna using the slot between the flange and the conductive film to resonate at a predetermined frequency.

Accordingly, an aspect of the present invention aims at providing a window glass for vehicle that enables a slot antenna resonating at a predetermined frequency.

### SUMMARY OF THE INVENTION

It is a general object of at least one embodiment of the present invention to provide a window glass for vehicle that substantially obviates one or more problems caused by the limitations and disadvantages of the related art.

In order to achieve the above-described purpose, according to an aspect of the present invention, a window glass for vehicle includes a glass plate; a dielectric body; and a conducting body arranged between the glass plate and the dielectric body. The conducting body includes a pair of feeding units; a first slot having a first open end that opens at an outer periphery of the conducting body, and extending from the first open end and through between the pair of feeding units; a second slot having a second open end that opens at the outer periphery of the conducting body, extending from the second open end, and being connected to the first slot; and a third slot having a non-open end that does not open at the outer periphery of the conducting body, extending from the non-open end, and being connected to the first slot and the second slot.

According to the embodiment, a slot antenna provided with the pair of feeding units, the first slot, the second slot, and the third slot can be formed. Therefore, irrespective of the slot between the flange of the vehicle body and the conducting body, a slot antenna that resonates at a predetermined frequency is enabled.

### BRIEF DESCRIPTION OF THE DRAWINGS

Other objects and further features of embodiments will become apparent from the following detailed description when read in conjunction with the accompanying drawings, in which:

FIG. 1 is an exploded view schematically depicting an example of a configuration of a window glass for vehicle according to an embodiment;

FIG. 2 is a plan view depicting an example of the configuration of the window glass for vehicle according to the embodiment;

FIG. 3 is a plan view depicting an example of a part of the configuration of the window glass for vehicle according to the embodiment;

FIG. 4 is a plan view depicting an example of a part of a configuration of a window glass for vehicle according to another embodiment;

FIG. 5 is a plan view depicting an example of a part of a configuration of a window glass for vehicle according to yet another embodiment;

FIG. 6 is a plan view depicting an example of a part of a configuration of a window glass for vehicle according to still another embodiment;

FIG. 7 is a cross-sectional diagram depicting an example of a configuration of a window glass for vehicle according to an embodiment;

FIG. 8 is a cross-sectional diagram depicting another example of the configuration of the window glass for vehicle according to the embodiment;

FIG. 9 is a cross-sectional diagram depicting yet another example of the configuration of the window glass for vehicle according to the embodiment;

FIG. 10 is a cross-sectional diagram depicting still another example of the configuration of the window glass for vehicle according to the embodiment;

FIG. 11 is a cross-sectional diagram depicting yet another example of the configuration of the window glass for vehicle according to the embodiment;

FIG. 12 is a diagram depicting an example of a slot according to another embodiment;

FIG. 13 is a diagram depicting an example of measured results of a reflection coefficient according to an embodiment;

FIG. 14 illustrates an example of measured results of an antenna gain at 174-240 MHz;

FIG. 15 illustrates an example of measured results of the antenna gain at 1400-1550 MHz;

FIG. 16 illustrates another example of the measured results of the antenna gain at 174-240 MHz; and

FIG. 17 is a plan view depicting an example of a part of a configuration of a window glass for vehicle according to another embodiment.

### DETAILED DESCRIPTION OF THE PREFERRED EMBODIMENTS

In the following, a window glass for vehicle according to embodiments of the present invention will be described with reference to the accompanying drawings. In the drawings for explaining configurations, when a direction is not especially described, the direction refers to a direction on the drawings. Reference directions in the respective drawings correspond to directions of symbols or numerals. Moreover, a direction, such as “parallel” or “orthogonal”, allows deviation enough to keep the effect of the present invention. As a window glass, the present invention can be applied to, for example, a front windshield that is arranged on a front part of a vehicle. The window glass may be a rear windshield that is arranged on a rear part of the vehicle, a side windshield that is arranged on a side part of the vehicle, a roof glass that is arranged on a ceiling part of the vehicle, or the like.

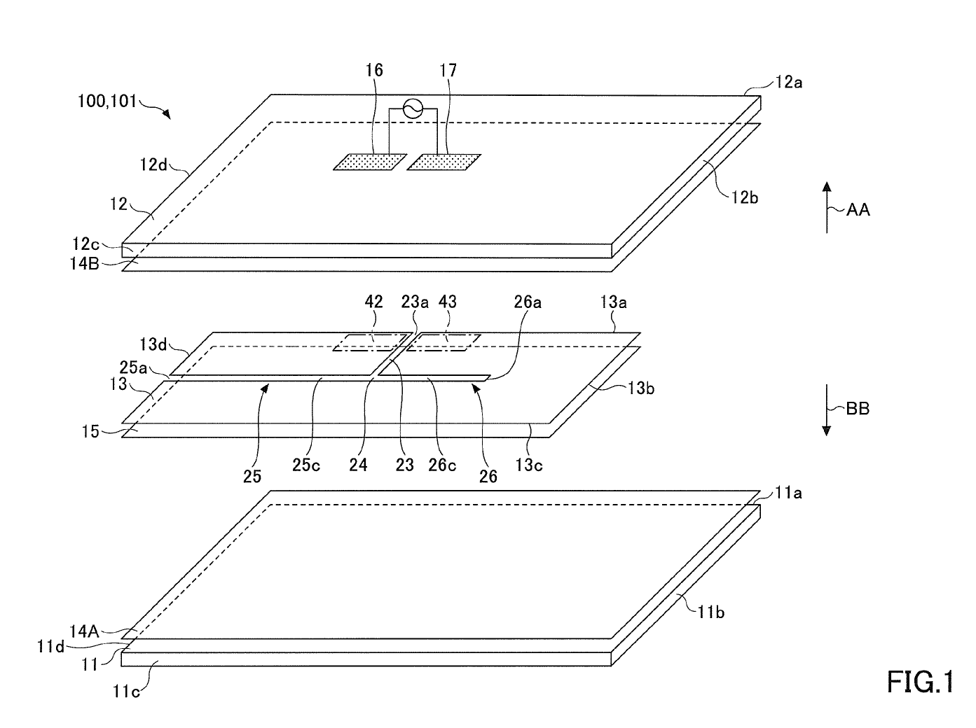

FIG. 1 is exploded view schematically depicting an example of a configuration of a window glass 100 according to an embodiment. The window glass 100 is an example of a window glass for vehicle. In FIG. 1, for example, a direction indicated by an arrow AA is a vehicle internal side, and a direction indicated by an arrow BB is a vehicle external side.

The window glass 100 is a laminated glass obtained by bonding a first glass plate 11 arranged on the vehicle external side and a second glass plate 12 arranged on the vehicle internal side via intermediate films 14A, 14B. FIG. 1 illustrates composition elements of the window glass 100 decomposed in a normal direction to a surface (main surface) of the first glass plate 11 (or the second glass plate 12). The window glass 100 is provided with the first glass plate 11, the second glass plate 12, and a conductive film 13.

The first glass plate 11 and the second glass plate 12 are transparent and plate-shaped dielectric bodies. Either of the first glass plate 11 and the second glass plate 12 may be translucent, or both the first glass plate 11 and the second glass plate 12 may be translucent.

The conductive film 13 is an example of a conducting body arranged between the first glass plate 11 and the second glass plate 12 so as to be expanded in a planar shape.

The conductive film 13 is arranged, for example, laminated on a surface of the vehicle internal side of the first glass plate 11 or on a surface of the vehicle external side of the second glass plate 12. When the window glass 100 is a laminated glass, the conductive film 13 may be arranged so as to be sandwiched by the first glass plate 11 and the second glass plate 12 that form the laminated glass, or sandwiched by the intermediate film and one of the glass plates.

The conductive film 13 may be a coat film formed on a surface of a glass plate by depositing a conductive material (e.g. silver) on the surface of the glass plate using a sputtering method or the like. Alternatively, the conductive film 13 may be a coat film formed on a surface of a resin film 15 (e.g. polyethylene terephthalate), which is a member different from the glass plates, by performing deposition on the surface of the resin film. Moreover, as the conductive material, for example, a zinc oxide based film (e.g. a zinc oxide film including gallium (GZO film)), ITO (complex oxide of indium and tin), gold, copper or the like may be used.

The conductive film 13 is provided with a pair of feeding units 42, 43, a first slot 23, a second slot 25, and a third slot 26.

The pair of feeding units 42, 43 is a conductor site of the conductive film 13 opposed to a pair of electrodes 16, 17 sandwiching the second glass plate 12 by the pair of electrodes 16, 17 and the pair of feeding units 42, 43.

The pair of electrodes 16, 17 is an example of a planar electrode arranged opposed to the conductive film 13 via the second glass plate 12 that is a dielectric body. A dielectric body is sandwiched by the pair of electrodes 16, 17 and the conductive film 13 that is a conductor. Therefore, one electrode 16 is coupled capacitively, via the second glass plate 12, with a projection region (i.e. feeding unit 42) that is a region where the electrode 16 is projected onto the conductive film 13. Another electrode 17 is coupled capacitively, via the second glass plate 12, with a projection region (i.e. feeding unit 43) that is a region where the electrode 17 is projected onto the conductive film 13. The pair of electrodes 16, 17 is arranged being exposed on a surface of the vehicle internal side of the second glass plate 12. The pair of electrodes 16, 17 is arranged in a direction which is orthogonal to a longitudinal direction of the first slot 23 and parallel to the surface of the second glass plate 12.

The first slot 23 has a first open end 23a that opens at an upper outer periphery 13a of the conductive film 13. The first slot 23 has a linear slot portion that extends linearly from the first open end 23a and through between the pair of feeding units 42, 43. One end of the first slot 23 opens at the first open end 23a on the upper outer periphery 13a of the conductive film 13, and another end of the first slot 23 is connected to a second slot 25 and a third slot 26 at an intersection point 24. The first slot 23 extends in a vertical direction which is orthogonal to the upper outer periphery 13a. However, the first slot 23 may extend in a vertical direction which is not orthogonal to the upper outer periphery 13a.

The second slot 25 has a second open end 25a that opens at a left outer periphery 13d of the conductive film 13. The second slot 25 has a linear slot portion 25c that extends linearly from the second open end 25a. One end of the second slot 25 opens at the second open end 25a on the left outer periphery 13d of the conductive film 13, and another end of the second slot 25 is connected to the first slot 23 and the third slot 26 at the intersection point 24. The second slot 25 extends parallel to the upper outer periphery 13a. However, the second slot 25 may extend not-parallel to the upper outer periphery 13a.

The third slot 26 has a non-open end 26a that does not open at an outer periphery of the conductive film 13. The third slot 26 has a linear slot portion 26c that extends linearly from the non-open end 26a. One end of the third slot 26 is the non-open end 26a that does not open at the outer periphery of the conductive film 13, and another end of the third slot 26 is connected to the first slot 23 and the second slot 25 at the intersection point 24. The third slot 26 extends parallel to the upper outer periphery 13a. However, the third slot 26 may extend not-parallel to the upper outer periphery 13a.

In FIG. 1, the second slot 25 and the third slot 26 intersect with the first slot 23 at the intersection point 24. The term “intersection” is not necessarily limited to a crosswise intersection, but may include T-shaped intersections, and other intersections formed by the slots.

Each slot is formed by, for example, irradiating the conductive film 13 with laser light, to remove the conductive film 13. Each slot may be formed by masking the conductive film 13 when the conductive film 13 is formed.

In this way, a slot antenna 101 can be formed provided with the pair of feeding units 42, 43, the first slot 23, the second slot 25, and the third slot 26. Therefore, the slot antenna 101 is enabled that resonates at a predetermined frequency by feeding the pair of feeding units 42, 43, irrespective of the slot between the flange of the vehicle body and the conductive film 13.

By feeding the pair of electrodes 16, 17, the pair of feeding units 42, 43, which is coupled capacitively with the pair of electrodes 16, 17, can be fed power. However, the method of feeding the pair of feeding units 42, 43 is not limited to the above. For example, the pair of feeding units 42, 43 may be fed power via a conductive member such as a conducting wire that directly contacts the pair of feeding units 42, 43.

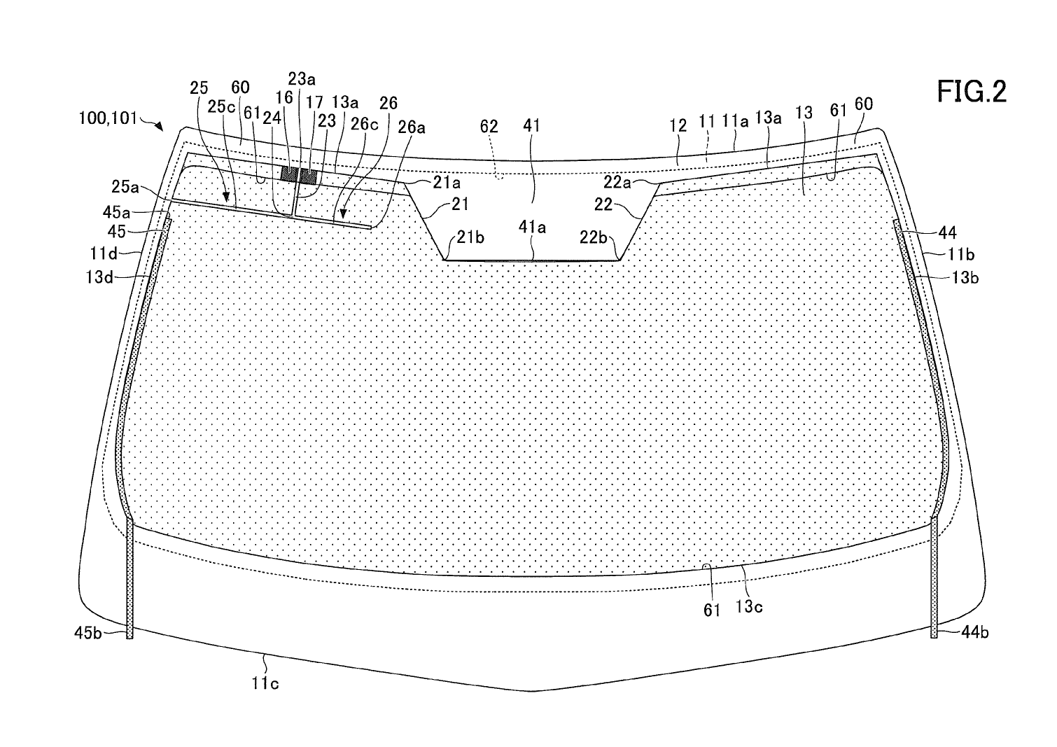

FIG. 2 is a plan view depicting an example of the configuration of the window glass 100 according to the embodiment. FIG. 2 illustrates a state where the first glass plate 11 overlaps with the second glass plate 12, and the conductive film 13 and the pair of bus bars 44, 45 are transparently seen through the second glass plate 12.

At least a part of the outer periphery of the conductive film 13 is offset, with respect to glass peripheries 11a to 11d that are outer peripheries of the first glass plate 11, toward the internal side of the first glass plate 11. At least the part of the outer periphery of the conductive film 13 may be flush with the glass peripheries 11a to 11d. The conductive film 13 includes an upper outer periphery 13a, a right outer periphery 13b, a lower outer periphery 13c, and a left outer periphery 13d. When the window glass 100 is a front windshield, the conductive film 13 is provided with a concave portion 41 that is recessed with respect to the upper outer periphery 13a. The shape of the conductive film 13 is not limited to that illustrated in the drawing.

The concave portion 41 is a region that is sandwiched by a first longitudinal edge side 21 and a second longitudinal edge side 22 in the horizontal direction. The first longitudinal edge side 21 and the second longitudinal edge side 22 are edges that extend downwardly from the upper outer periphery 13a of the conductive film 13, and parts of the outer periphery of the conductive film 13. The first longitudinal edge side 21 is an example of an outer periphery of the conductive film 13 extending in the vertical direction, and extends from an upper left end 21a of the upper outer periphery 13a on the left side to a lower left end 21b. The second longitudinal edge side 22 is an example of an outer periphery of the conductive film 13 extending in the vertical direction, and extends from an upper right end 22a of the upper outer periphery 13a on the right side to a lower right end 22b. A lower side 41a is an edge that connects a lower left end 21b and the lower right end 22b, and is a part of the outer periphery of the conductive film 13. The lower side 41a is also a lower end of the concave portion 41.

The conductive film 13 is a transparent or translucent film having conductivity. The conductive film 13 is, for example, a heat reflecting film having conductivity that can reflect heat coming from the vehicle external side. Alternatively, the conductive film 13 is, for example, a conducting body in which an electric current flows in the conductive film 13 by applying a direct current voltage between the pair of bus bars 44, 45, and thereby the window glass 100 is heated and melting of snow and ice and antifogging of the window glass 100 are enabled. The use of the conductive film 13 is not limited to them.

The window glass 100 includes the pair of bus bars 44, 45 that is arranged between the first glass plate 11 and the second glass plate 12, which are opposed to each other. A right bus bar 44 and a left bus bar 45 are examples of band-like electrodes for applying a direct current to the conductive film 13, respectively.

The right bus bar 44 is an example of a right band-like electrode arranged on the right outer periphery 13b of the conductive film 13. The right bus bar 44 is a first lateral band-like electrode that extends in a longitudinal direction along the right outer periphery 13b, and conductively contacts the right outer periphery 13b of the conductive film 13.

The left bus bar 45 is an example of a left band-like electrode arranged on the left outer periphery 13d of the conductive film 13. The left bus bar 45 is a second lateral band-like electrode that extends in a longitudinal direction along the left outer periphery 13d, and conductively contacts the left outer periphery 13d of the conductive film 13.

In order to apply a direct current voltage to the pair of bus bars 44, 45 for causing an electric current to flow in the conductive film 13, a negative electric voltage side of the direct current voltage is connected to the left bus bar 45, and a high electric voltage side of the direct current voltage is connected to the right bus bar 44. According to this configuration, the direct current voltage can be applied to the conductive film 13.

For example, in a state where the window glass 100 is mounted on a vehicle, a power supply part for vehicle is conductively connected to the right bus bar 44, and a ground part on the vehicle is conductively connected to the left bus bar 45. The power supply part is, for example, a positive electrode of a direct current power source such as a battery. The ground part is, for example, a negative electrode of the direct current power source such as a battery, or a vehicle body frame (body ground).

The negative electric voltage side (e.g. the ground part) of a direct current voltage is preferably connected to a bus bar of the pair of bus bars 44, 45, that is closer to the slot antenna 101, i.e. the left bus bar 45. According to this configuration, high-frequency noise emitted from the power supply part connected to the right bus bar 44 can be prevented from propagating to the respective slots 23, 25, and 26 of the slot antenna 101.

On the contrary, in order to apply a direct electric current to the conductive film 13, the high electric voltage side of the direct current voltage may be connected to the left bus bar 45, and a low electric voltage side of the direct current voltage may be connected to the right bus bar 44. For example, the power supply part is conductively connected to the left bus bar 45, and the ground part is conductively connected to the right bus bar 44.

The conductive connection configuration between each bus bar and the power supply part or the ground part is not particularly limited. For example, when the respective bus bars are laminated inside the laminated glass, each bus bar is conductively connected to the power supply part or the ground part via an electrode extraction part such as a copper foil drawn from an outer periphery part of the laminated glass. Alternatively, the power supply part or the ground part may be conductively connected to each bus bar exposed on a surface of the laminated glass.

FIG. 2 illustrates electrode extraction parts 44b, 45b. The electrode extraction part 44b is a conducting body that extends from a lower end part of the right bus bar 44. The electrode extraction part 45b is a conducting body that extends from a lower end part of the left bus bar 45.

The window glass 100 may be provided with a shielding film 60 for shielding a part of or all of the outer periphery part of the conductive film 13. The shielding film 60 is arranged between the conductive film 13 and the first glass plate 11. According to this configuration, when the window glass 100 is viewed from the vehicle external side, in a planar view, it is difficult to see a part that overlaps with the shielding film 60, and design property of the window glass 100 is improved.

The shielding film 60 is, for example, a ceramics formed on a surface of the first glass plate 11. A specific example of the shielding film 60 includes a sintered body such as a black ceramic film.

The shielding film 60 is formed between a shielding periphery 61 and the glass peripheries 11a-11d in the planar view of the window glass 100. The shielding periphery 61 is a film periphery of the shielding film 60. In FIG. 2, the shielding film 60 shields an upper periphery of the conducting film 13, and the pair of electrodes 16, 17. However, the shielding film 60 may shield the slot antenna 101 and the respective bus bars.

In a state where the window glass 100 is attached to a window frame of the vehicle (which is also referred to as a flange), a periphery 62 of the window frame is located between the outer peripheries 13a-13d of the conductive film 13 and the glass peripheries 11a-11d of the first glass plate 11. When the window frame is metallic, an open end of slot (e.g. at least one of the first open end 23a and the second open end 25a) is located, as illustrated in FIG. 2, at a position which does not overlap with the window frame in the planar view of the first glass plate 11. Because the open end of the slot is not shielded by the vehicle body, the slot antenna 101 can be operated correctly. When the window frame is made of resin, the open end of the slot may overlap with the window frame in the planar view of the first glass plate 11. In the case the window frame made of resin, even if the open end of the slot is shielded by the vehicle body, the slot antenna 101 can be operated correctly.

FIG. 2 illustrates a configuration in which the slot antenna 101 is arranged on the left side of the concave portion 41. Similarly, the slot antenna 101 may be arranged on the right side of the concave portion 41. Furthermore, the slot antennas 101 may be arranged on both sides of the concave portion 41. The plurality of slot antennas can be used as a multi-band antenna, a diversity antenna, or an MIMO (Multi-Input Multi-Output) antenna.

Each of the slots 23, 25 and 26 has a shape of rectangle. Configurations (shapes, dimensions or the like) of the respective slots 23, 25, and 26, and the pair of electrodes 16, 17 are required to be set so as to satisfy requirement values for antenna gains necessary for receiving electric waves of the frequency band that the slot antenna 101 is to receive. For example, when the frequency band that the slot antenna 101 is to receive is the frequency band of the terrestrial digital television broadcasting, 470-770 MHz, the respective slots 23, 25, and 26, and the pair of electrodes 16, 17 are formed so as to be adapted for receiving electric waves of the frequency band of the terrestrial digital television broadcasting.

When a coaxial cable is used for a feeding line (transmission line) for feeding power to the pair of feeding units 42, 43 (See FIG. 1) via the pair of electrodes 16, 17, for example, an internal conductor of the coaxial cable is electrically connected to the electrode 16, and an external conductor of the coaxial cable is electrically connected to the electrode 17. Moreover, a configuration, in which a connector for electrically connecting a transmission line such as a coaxial cable to the pair of electrodes 16, 17 is implemented in the pair of electrodes 16, 17, may be employed. According to the connector described as above, a signal line of the transmission line can be attached easily to the pair of electrodes 16, 17. Moreover, a configuration, in which a projection-shaped conductive member (an example of transmission line) is provided in the pair of electrodes 16, 17, and the projection-shaped conductive member contacts and fits into a feeding site provided in a flange part of the vehicle body to which the window glass is attached, may be employed.

A shape of the pair of electrodes 16, 17 is determined taking into account the shape of an implementation surface or the like of the conductive member or the connector. For example, the shape of electrodes is preferably rectangular, such as square, approximately square, rectangular or approximately rectangular; or a polygonal shape, in implementation. Moreover, the shape of electrodes may be circular, such as a circle, approximately circular, elliptic, or approximately elliptic.

Moreover, the pair of electrodes 16, 17 is formed by, for example, printing a paste including conductive metal, such as a silver paste, on a surface of the second glass plate 12 on the vehicle internal side, and baking. However, the formation method is not limited to this, and the pair of electrodes 16, 17 may be a linear body or a foil type body made of a conductive material such as copper formed on the surface of the second glass plate 12 on the vehicle internal side. The linear body or the foil type body may be bonded to the second glass plate 12 using an adhesive or the like.

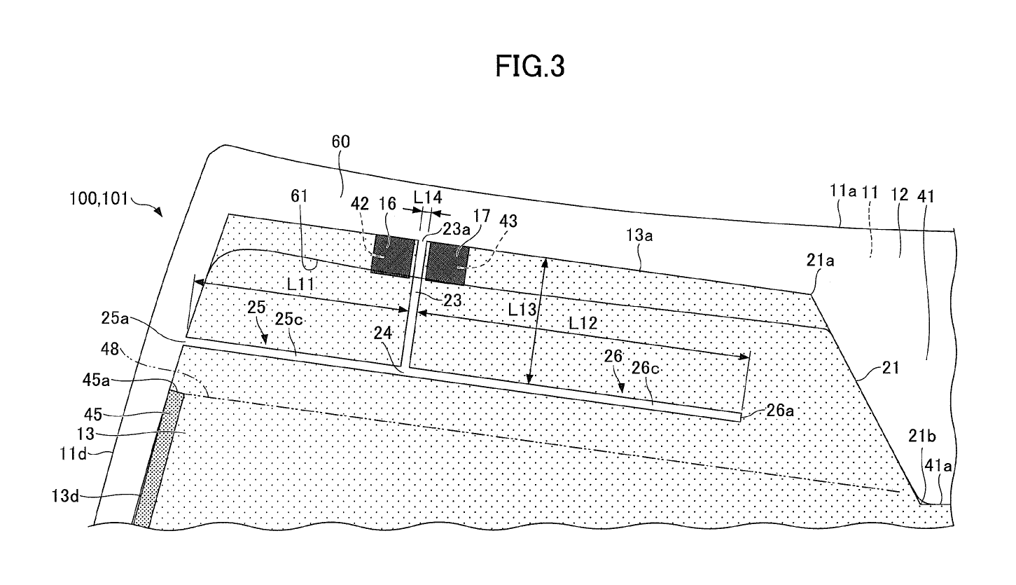

FIG. 3 is a plan view partially depicting an example of the configuration of the window glass 100. FIG. 3 illustrates an inverted F-shaped slot antenna 101 in an enlarged form.

The first open end 23a is opened at the upper outer periphery 13a, and the second open end 25a is opened at the left outer periphery 13d. The upper outer periphery 13a is an example of an outer periphery of the upper side of the conductive film 13. The left outer periphery 13d is an example of an outer periphery of the conductive film 13 extending in the vertical direction, and is located on the left part of the conductive film 13. The pair of feeding units 42, 43 and the part of electrodes 16, 17 are located along the upper outer periphery 13a.

The third slot 26 is preferably located above an upper end part 45a of the left bus bar 45 in enhancing antenna gain. For example, the third slot 26 is located above a virtual line 48 indicated by a two-dot chain line. The virtual line 48 is a line passing through the upper end part 45a, and any point on a lower side 41a of the concave portion 41.

At least one of the first slot 23, the second slot 25, the third slot 26, and the pair of feeding units 42, 43 may be located above the upper end part 45a of the left bus bar 45 in the planar view of the first glass plate 11 in enhancing antenna gain.

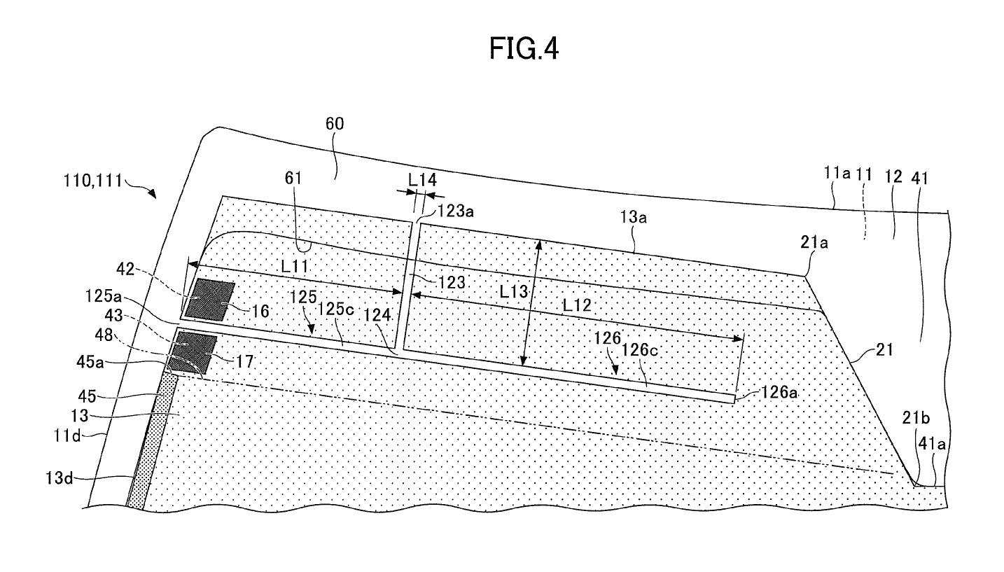

FIG. 4 is a plan view partially depicting an example of a configuration of a window glass 110 according to another embodiment. FIG. 4 illustrates an inverted F-shaped slot antenna 111 in an enlarged form. Because the configuration of the window glass 110 is the same as the window glass 100, for an explanation thereof, the above-described explanation for the window glass 100 will be incorporated. The same applies to other window glasses, which will be described below.

The pair of feeding units 42, 43 and the pair of electrodes 16, 17 are located along the left outer periphery 13d, and above the upper end part 45a of the left bus bar 45.

The first slot 125 has a first open end 125a that opens at the left outer periphery 13d of the conductive film 13. The first slot 125 has a linear slot portion 125c that linearly extends from the first open end 125a and through between the pair of feeding units 42, 43. One end of the first slot 125 opens at the first open end 125a on the left outer periphery 13d of the conductive film 13, and another end of the first slot 125 is connected to a second slot 123 and a third slot 126 at an intersection point 124.

The second slot 123 has a second open end 123a that opens at an upper outer periphery 13a of the conductive film 13. The second slot 123 has a linear slot portion that extends linearly from the second open end 123a. One end of the second slot 123 opens at the second open end 123a on the upper outer periphery 13a of the conductive film 13, and another end of the second slot 123 is connected to the first slot 125 and the third slot 126 at the intersection point 124.

The third slot 126 has a non-open end 126a that does not open at an outer periphery of the conductive film 13. The third slot 126 has a linear slot portion 126c that extends linearly from the non-open end 126a. One end of the third slot 126 is the non-open end 126a that does not open on the outer periphery of the conductive film 13, and another end of the third slot 126 is connected to the first slot 125 and the second slot 123 at the intersection point 124.

In this way, a slot antenna 111 can be formed provided with the pair of feeding units 42, 43, the first slot 125, the second slot 123, and the third slot 126. Therefore, the slot antenna 111 is enabled that resonates at a predetermined frequency by feeding the pair of feeding units 42, 43, irrespective of the slot between the flange of the vehicle body and the conductive film 13.

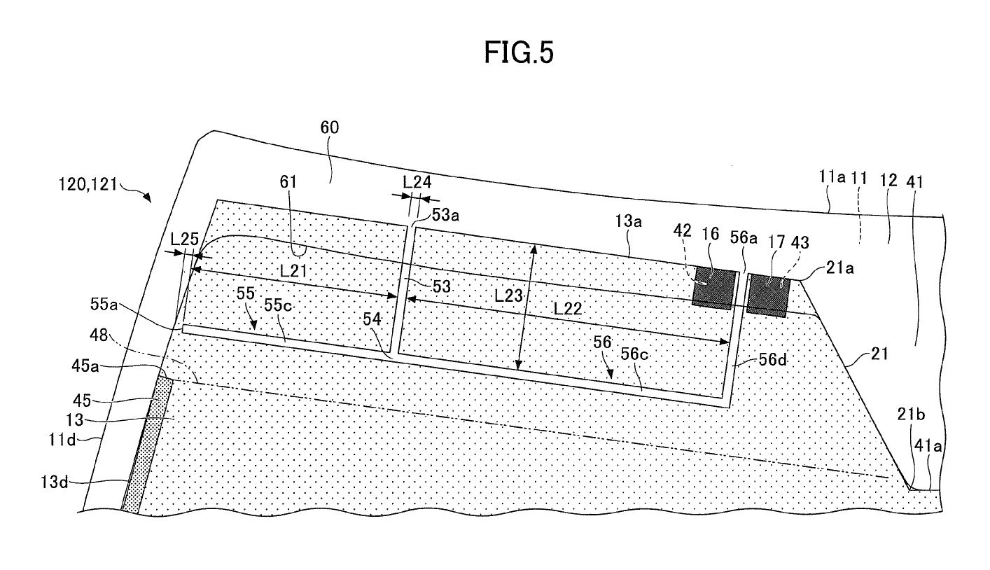

FIG. 5 is a plan view partially depicting an example of a configuration of a window glass 120 according to yet another embodiment. FIG. 5 illustrates an inverted F-shaped slot antenna 121 in an enlarged form.

The first open end 56a opens at the upper outer periphery 13a, and the second open end 53a opens at the upper outer periphery 13a that is the same as the first open end 56a. The pair of feeding units 42, 43 and the pair of electrodes 16, 17 are located along the upper outer periphery 13a.

The first slot 56 has the first open end 56a that opens at the upper outer periphery 13a of the conductive film 13. The first slot 56 has a linear slot portion 56d that linearly extends from the first open end 56a and through between the pair of feeding units 42, 43, and a linear slot portion 56c that extends from an end part of the linear slot portion 56d and parallel to the upper outer periphery 13a. One end of the first slot 56 opens at the first open end 56a on the upper outer periphery 13a of the conductive film 13, and another end of the first slot 56 is connected to a second slot 53 and a third slot 55 at an intersection point 54.

The second slot 53 has a second open end 53a that opens at an upper outer periphery 13a of the conductive film 13. The second slot 53 has a linear slot portion that extends linearly from the second open end 53a. One end of the second slot 53 opens at the second open end 53a on the upper outer periphery 13a of the conductive film 13, and another end of the second slot 53 is connected to the first slot 56 and the third slot 55 at the intersection point 54.

The third slot 55 has a non-open end 55a that does not open at an outer periphery of the conductive film 13. The third slot 55 has a linear slot portion 55c that extends linearly from the non-open end 55a. One end of the third slot 55 is the non-open end 55a that does not open on the outer periphery of the conductive film 13, and another end of the third slot 55 is connected to the first slot 56 and the second slot 53 at the intersection point 54.

In this way, a slot antenna 121 can be formed provided with the pair of feeding units 42, 43, the first slot 56, the second slot 53, and the third slot 55. Therefore, the slot antenna 121 is enabled that resonates at a predetermined frequency by feeding the pair of feeding units 42, 43, irrespective of the slot between the flange of the vehicle body and the conductive film 13.

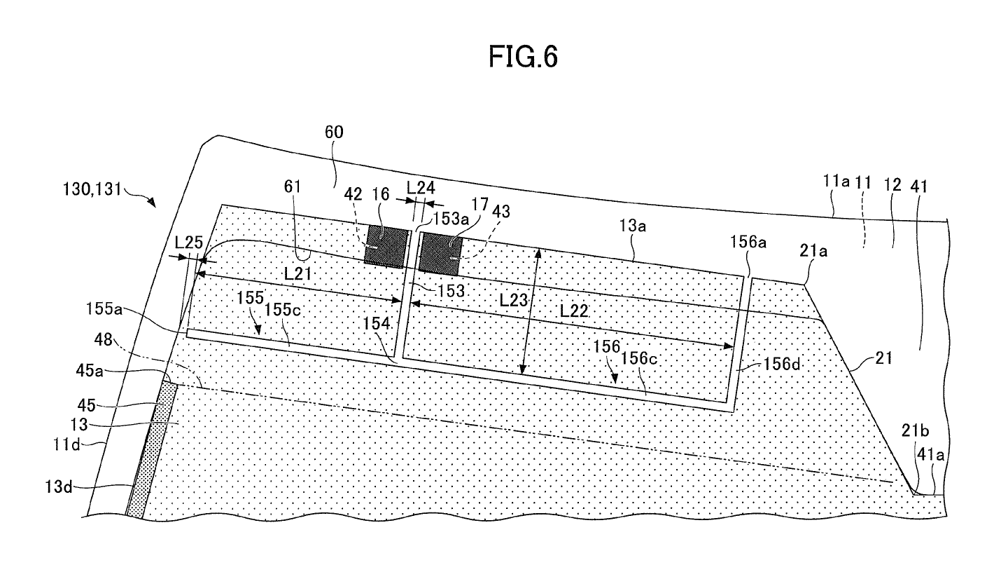

FIG. 6 is a plan view partially depicting an example of a configuration of a window glass 130 according to still another embodiment. FIG. 6 illustrates an inverted F-shaped slot antenna 131 in an enlarged form.

The first open end 153a opens at the upper outer periphery 13a, and the second open end 156a opens at the upper outer periphery 13a that is the same as the first open end 153a. The pair of feeding units 42, 43 and the pair of electrodes 16, 17 are located along the upper outer periphery 13a.

The first slot 153 has a first open end 153a that opens at an upper outer periphery 13a of the conductive film 13. The first slot 153 has a linear slot portion that extends linearly from the first open end 153a and through between the pair of feeding units 42, 43. One end of the first slot 153 opens at the first open end 153a on the upper outer periphery 13a of the conductive film 13, and another end of the first slot 153 is connected to a second slot 156 and a third slot 155 at an intersection point 154.

The second slot 156 has the second open end 156a that opens at the upper outer periphery 13a of the conductive film 13. The second slot 156 has a linear slot portion 156d that linearly extends from the second open end 156a, and a linear slot portion 156c that extends from an end part of the linear slot portion 156d and parallel to the upper outer periphery 13a. One end of the second slot 156 opens at the second open end 156a on the upper outer periphery 13a of the conductive film 13, and another end of the second slot 156 is connected to the first slot 153 and the third slot 155 at the intersection point 154.

The third slot 155 has a non-open end 155a that does not open at an outer periphery of the conductive film 13. The third slot 155 has a linear slot portion 155c that extends linearly from the non-open end 155a. One end of the third slot 155 is the non-open end 155a that does not open on the outer periphery of the conductive film 13, and another end of the third slot 155 is connected to the first slot 153 and the second slot 156 at the intersection point 154.

In this way, a slot antenna 131 can be formed provided with the pair of feeding units 42, 43, the first slot 153, the second slot 156, and the third slot 155. Therefore, the slot antenna 131 is enabled that resonates at a predetermined frequency by feeding the pair of feeding units 42, 43, irrespective of the slot between the flange of the vehicle body and the conductive film 13.

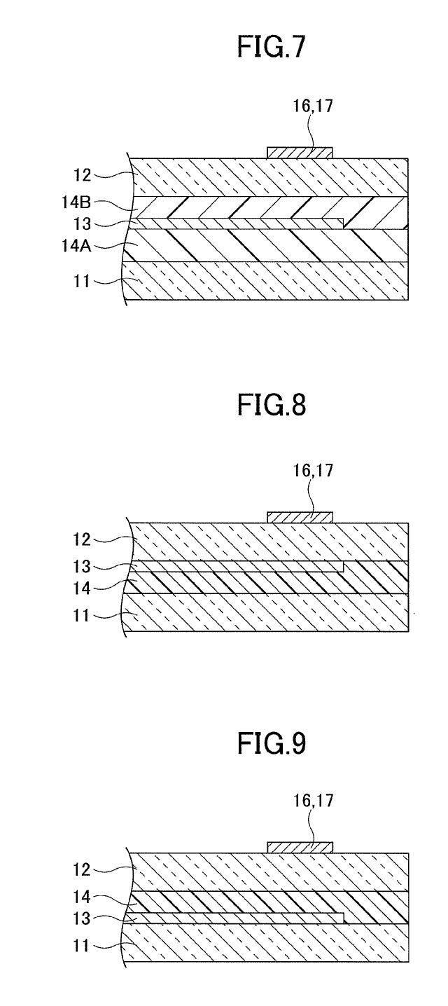

FIGS. 7 to 11 illustrate variations of the configuration of lamination included in the window glass according to the embodiment. In FIGS. 7 to 11, the conductive film 13 is arranged between the first glass plate 11 and the dielectric body (the second glass plate 12 or a dielectric substrate 32). A part of or all of the pair of electrodes 16, 17 are arranged so as to overlap with the conductive film 13, viewed from the lamination direction.

In the case of FIGS. 7 to 9, the conductive film 13 and the intermediate film 14 (or the intermediate films 14A, 14B) are arranged between the first glass plate 11 and the second glass plate 12. FIG. 7 illustrates a configuration in which the conducting film 13 is sandwiched by the intermediate film 14A that contacts a surface of the first glass plate 11 opposite to the second glass plate 12 and the intermediate film 14B that contacts a surface of the second glass plate 12 opposite to the first glass plate 11. The conductive film 13 may be a coat film formed on a surface of a predetermined resin film, such as polyethylene terephthalate, obtained by depositing a conductive material on the surface of the resin film. FIG. 8 illustrates a configuration in which the conductive film 13 is a coat film formed on the second glass plate 12, obtained by depositing a conductive material on the surface of the second glass plate 12 opposite to the first glass plate 11. FIG. 9 illustrates a configuration in which the conductive film 13 is a coat film formed on the first glass plate 11, obtained by depositing a conductive material on the surface of the first glass plate 11 opposite to the second glass plate 12.

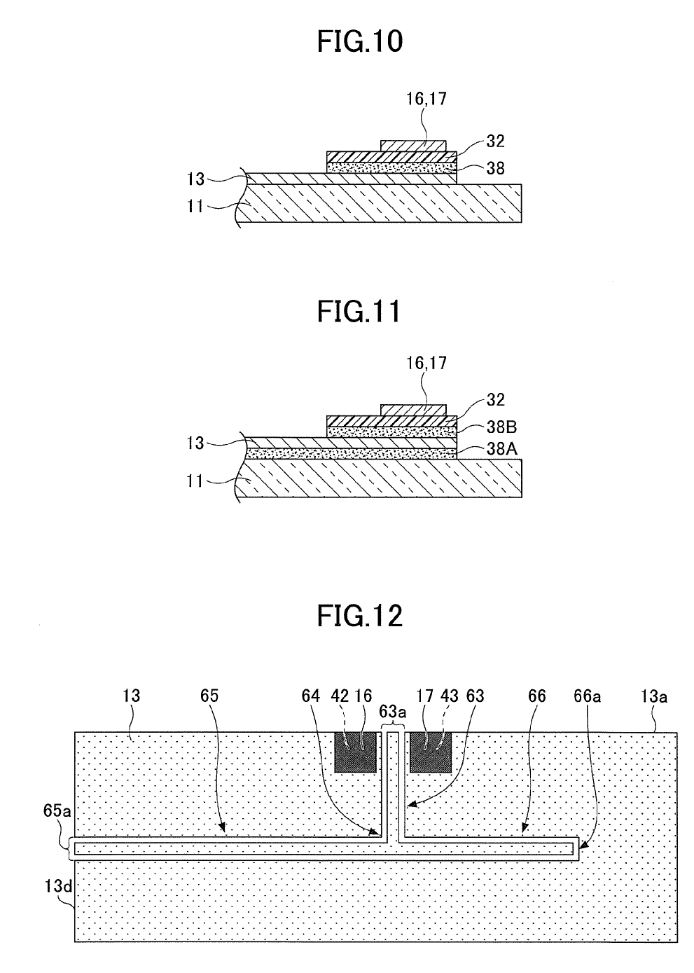

Moreover, as illustrated in FIGS. 10, 11, the window glass for vehicle according to the embodiment may not be a laminated glass. In this case, the dielectric body may not be the same size as the first glass plate 11, and may be a dielectric substrate or the like having a size allowing the pair of electrodes 16, 17 to be formed. In the case of FIGS. 10, 11, the conductive film 13 is arranged between the first glass plate 11 and the dielectric substrate 32. FIG. 10 illustrates a configuration in which the conductive film 13 is a coat film formed on the first glass plate 11, obtained by depositing a conductive material on the surface of the first glass plate 11 opposite to the dielectric substrate 32. The conductive film 13 and the dielectric substrate 32 are bonded by a bonding layer 38. FIG. 11 illustrates a configuration in which the conductive film 13 is bonded by the bonding layer 38A to the surface of the first glass plate 11 opposite to the dielectric substrate 32. The conductive layer 13 and the dielectric substrate 32 are bonded by a bonding layer 32B. The dielectric substrate 32 is a resin substrate, and is provided with a pair of electrodes 16, 17. The dielectric substrate 32 may be a resin printed substrate on which the pair of electrodes 16, 17 is printed (e.g. a glass epoxy substrate obtained by attaching a copper foil to an FR4).

FIG. 12 is a diagram depicting an example of a slot according to another embodiment. As illustrated in FIG. 12, each slot may be a multi slot including a plurality of fine slots that run parallel to each other. FIG. 12 illustrates each slot illustrated in FIG. 3 in a form of multi slots.

The first slot 63 has a first open end 63a that opens at an upper outer periphery 13a of the conductive film 13. The second slot 65 has a second open end 65a that opens at a left outer periphery 13d of the conductive film 13. The third slot 66 has a non-open end 66a that does not open at the outer periphery of the conductive film 13.

### EXAMPLE 1

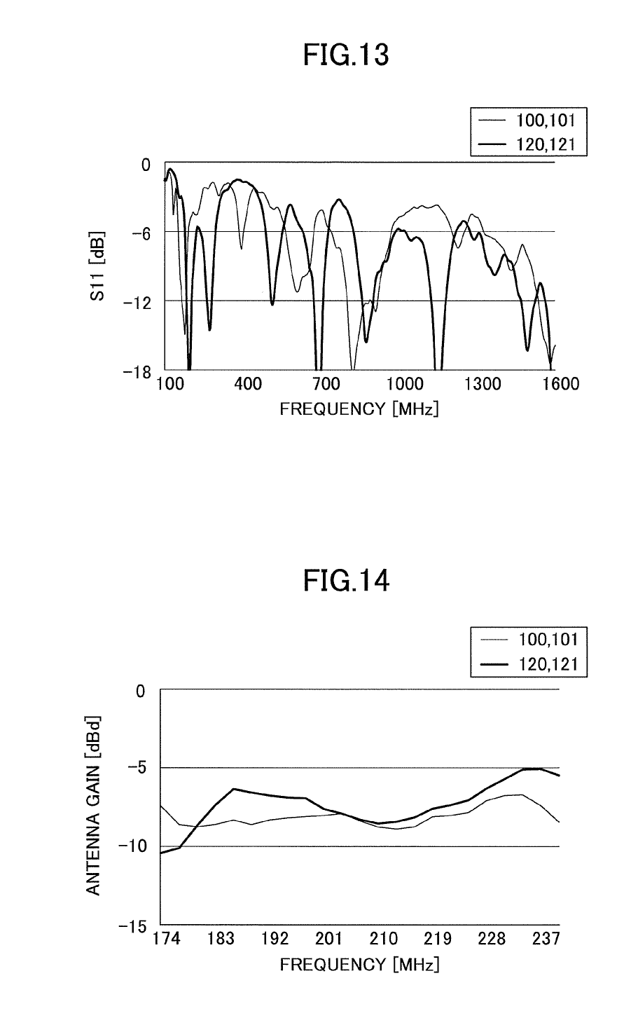

FIGS. 13 to 15 depict an example of results of measurements for reflection coefficient S11 and antenna gain of the slot antenna when the window glass was attached to a frame of a front windshield of an actual vehicle. FIGS. 13 to 15 illustrate results in the case of the window glass 100 (FIG. 3) that enables the slot antenna 101, and results in the case of the window glass 120 (FIG. 5) that enables the slot antenna 121.

In the case of FIGS. 13 to 15, in the measurement of the reflection coefficient S11 and the antenna gain, for convenience in experiment, a window glass in which a coat film is formed on a vehicle internal side of the second glass plate 12 that is arranged on the vehicle internal side was used. This coat film was a silver-based conductive film formed by using a sputtering apparatus. A sheet resistance of the coat film is 1.0 S2. On this coat film, the respective slots according to the present invention were formed, and a dielectric substrate provided with the pair of electrodes 16, 17 was bonded to the coat film.

The reflection coefficient S11 was measured in a state where the window glass was attached to the window frame of the vehicle front windshield in an anechoic chamber, and the antenna part was inclined by about 25° with respect to the horizontal plane. The reflection coefficient S11 was measured in a state where the right bus bar 44 and the left bus bar 45 (See FIG. 2) were formed by attaching copper foils, and the electrode extraction parts 44b, 45b (See FIG. 2) were connected to the vehicle frame (body ground). A connector was attached so that an internal electrode of the coaxial cable was connected to the electrode 16 and an external electrode of the coaxial cable was connected to the electrode 17, the pair of electrodes 16, 17 was connected to a network analyzer via the coaxial cable. The reflection coefficient S11 was measured within a frequency range of 100 to 1600 MHz.

FIG. 13 depicts an example of the results of measurement for the reflection coefficient S11. FIG. 13 illustrates results in the case of the window glass 100 (FIG. 3) that enables the slot antenna 101, and results in the case of the window glass 120 (FIG. 5) that enables the slot antenna 121. As illustrated in FIG. 13, in any case, a matching was completed in the frequency band of the terrestrial digital television broadcasting and in the frequency band of the digital audio broadcasting (DAB). That is, the slot antennas 101, 121 that resonated at a frequency in the frequency bands of the terrestrial digital television broadcasting and in the frequency band of the digital audio broadcasting (DAB) were enabled.

The frequency band of the terrestrial digital television broadcasting is 470-770 MHz. The frequency band of the DAB includes two different frequency bands, i.e. the band III of 174-240 MHz and the L band of 1452-1492 MHz.

The antenna gain was measured in a state where the window glass was attached to the window frame of the vehicle front windshield in the anechoic chamber, and the antenna part was inclined by about 25° with respect to the horizontal plane. The connector, which was connected to an end of the coaxial cable so that an internal conductor of the coaxial cable was connected to the electrode 16 and an external conductor of the coaxial cable was connected to the electrode 17, was attached to the electrodes 16, 17. The external conductor of the coaxial cable was threadably mounted on the vehicle body at a site separated from the connector by 180 mm. The antenna gain was measured within the range of 174-240 MHz, including the frequency band of the band 3, every 3 MHz, and within the range of 1400 -1550 MHz, including the frequency band of the L band, every 6.8 MHz.

FIG. 14 depicts an example of the results of measurement for the antenna gain within the range of 174-240 MHz. A power average of the antenna gain measured every 3 MHz in the range of 174-240 MHz was −8.0 dBd for the window glass 100 (FIG. 3) that enables the slot antenna 101, and −7.1 dBd for the window glass 120 (FIG. 5) that enables the slot antenna 121.

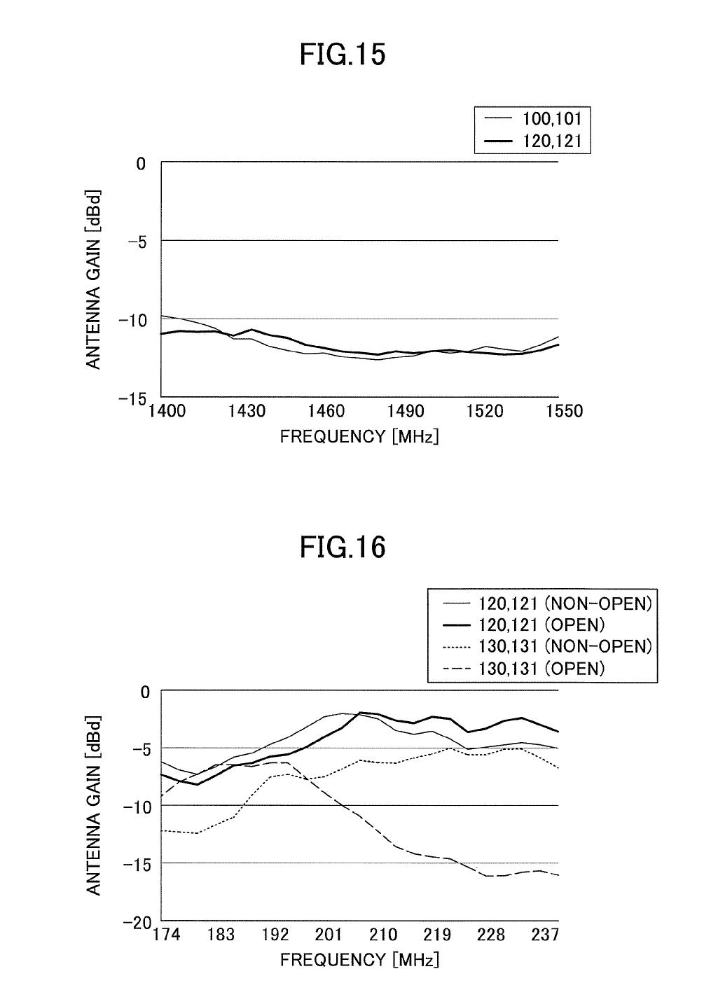

FIG. 15 depicts an example of the results of measurement for the antenna gain within the range of 1400-1550 MHz. A power average of the antenna gain measured every 6.8 MHz in the range of 1400-1550 MHz was −11.6 dBd for the window glass 100 (FIG. 3) that enables the slot antenna 101, and −11.6 dBd for the window glass 120 (FIG. 5) that enables the slot antenna 121.

In FIGS. 13 to 15, dimensions of the respective elements when the reflection coefficient and the antenna gain were measured were as follows (in units of mm),

L11+L12: 331,

L13: 79, and

L14: 5

for the configuration of FIG. 3. For the configuration of FIG. 5, the dimensions were

L21: 129,

L22: 202,

L23: 79,

L24: 5, and

L25: 5.

The shapes of the electrodes 16, 17 were squares whose side length was 24 mm, respectively. A pitch between the electrode 16 and the electrode 17 was 10 mm.

### EXAMPLE 2

FIG. 16 depicts an example of results of measurements for antenna gain when the window glass was attached to a frame of a front windshield of an actual vehicle. The results for the window glass 120 (FIG. 5) that enables the slot antenna 121 are indicated by “120, 121 (non-open)”. The results for the window glass 120 (FIG. 5) that enables the slot antenna 121, in which the third slot 55 was extended to the left outer periphery 13d and the non-open end 55a was changed to an open end, are indicated by “120, 121 (open)”. The results for the window glass 130 (FIG. 6) that enables the slot antenna 131 are indicated by “130, 131 (non-open)”. The results for the window glass 130 (FIG. 6) that enables the slot antenna 131, in which the third slot 155 was extended to the left outer periphery 13d and the non-open end 155a was changed to an open end, are indicated by “130, 131 (open)”.

In the case of FIG. 16, in the measurement of the antenna gain, for convenience in experiment, a window glass in which copper foils were attached to the vehicle external side surface of the first glass plate 11 that is arranged on the vehicle external side was used. That is, in FIG. 9, the copper foils that represent the conductive film 13 were located on a side opposite to the illustrated position with respect to the first glass plate 11.

The antenna gain was measured in a state where the window glass was attached to the window frame of the vehicle front windshield in an anechoic chamber, and the antenna part was inclined by about 25° with respect to the horizontal plane. The connector, which was connected to an end of the coaxial cable so that an internal conductor of the coaxial cable was connected to the electrode 16 and an external conductor of the coaxial cable was connected to the electrode 17, was attached to the electrodes 16, 17. The external conductor of the coaxial cable was threadably mounted on the vehicle body at a site separated from the connector by 180 mm. The antenna gain was measured every 3 MHz within the range of 174-240 MHz, including the frequency band of the band 3.

FIG. 16 depicts an example of the results of measurement for the antenna gain within the range of 174-240 MHz.

When one end of the third slot 55, illustrated in FIG. 5, was a non-open end 55a (120, 121 (non-open)), a power average of the antenna gain measured every 3 MHz within the range of 174-240 MHz was −4.3 dBd. When one end of the third slot 55, illustrated in FIG. 5, was an open end (120, 121 (open)), a power average of the antenna gain measured every 3 MHz within the range of 174-240 MHz was −3.9 dBd.

When one end of the third slot 155, illustrated in FIG. 6, was a non-open end 155a (130, 131 (non-open)), a power average of the antenna gain measured every 3 MHz within the range of 174-240 MHz was −7.0 dBd. When one end of the third slot 155, illustrated in FIG. 6, was an open end (130, 131 (open)), a power average of the antenna gain measured every 3 MHz within the range of 174-240 MHz was −9.7 dBd.

Therefore, in the case illustrated in FIG. 5, in which a distance between the pair of feeding units 42, 43 and the non-open end (or open end) of the third slot is longer, a greater antenna gain is obtained than the case illustrated in FIG. 6, in which the distance is shorter. Moreover, in FIG. 6, in the case where one end of the third slot 155 is the non-open end 155a, a greater antenna gain is obtained than the case where one end of the third slot 155 is the open end.

As described above, the window glass for vehicle has been described with reference to the embodiments. However, the present invention is not limited to these examples, but various variations and modifications may be made without deviating from the scope of the present invention.

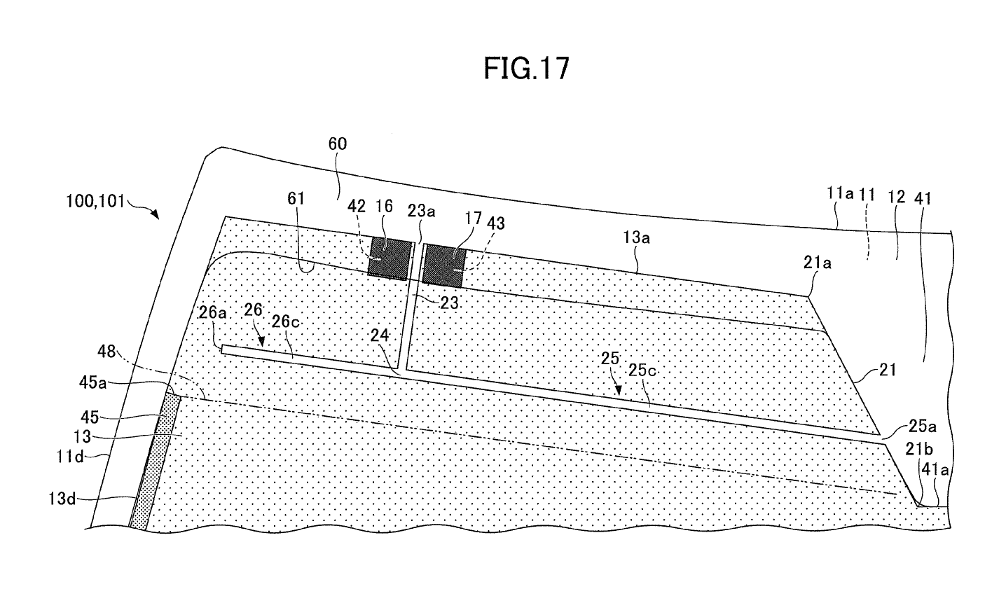

For example, FIG. 17 depicts a variation of the configuration illustrated in FIG. 3. In FIG. 17, the first open end 23a opens at the upper outer periphery 13a, and the second open end 25a opens at the first longitudinal edge side 21. The second slot 25 has a linear slot portion 25c that extends linearly between the intersection point 24 and the first longitudinal edge side 21. The third slot 26 has a linear slot portion 26c that extends linearly between the intersection point 24 and the non-open end 26a. The linear slot portion 26c extends linearly from the intersection point toward the left outer periphery so as not to open at the left outer periphery 13d of the conductive film 13.

What is claimed is:

1. A window glass for vehicle comprising a glass plate; a dielectric body; and a conducting body arranged between the glass plate and the dielectric body,
wherein the conducting body includes
a pair of feeding units;
a first slot having a first open end that opens at an outer periphery of the conducting body, and extending from the first open end and through between the pair of feeding units;
a second slot having a second open end that opens at the outer periphery of the conducting body, extending from the second open end, and being connected to the first slot; and
a third slot having a non-open end that does not open at the outer periphery of the conducting body, extending from the non-open end, and being connected to the first slot and the second slot.

2. The window glass for vehicle according to claim 1,
wherein, in a planar view of the glass plate, the first open end opens at an upper outer periphery of the conducting body, and the second open end opens at an outer periphery of the conducting body that extends in a vertical direction.

3. The window glass for vehicle according to claim 1,
wherein, in a planar view of the glass plate, the first open end opens at an upper outer periphery of the conducting body, and the second open end opens at the upper outer periphery of the conducting body.

4. The window glass for vehicle according to claim 1, further comprising:
a band-like electrode arranged between the glass plate and the dielectric body for applying a direct current to the conductive body,
wherein at least one of the first slot, the second slot, the third slot, and the pair of feeding units is located above an upper end of the band-like electrode in a planar view of the glass plate.
